(19) United States
(12) Patent Application Publication
(10) Pub. No.: US 2025/0202271 A1
(43) Pub. Date: Jun. 19, 2025

(54) SOLAR CHARGING CONTROL DEVICE AND VEHICLE

(71) Applicant: TOYOTA JIDOSHA KABUSHIKI KAISHA, Toyota-shi (JP)

(72) Inventor: Takao SAITOH, Toyota-shi (JP)

(73) Assignee: TOYOTA JIDOSHA KABUSHIKI KAISHA, Totoya-shi (JP)

(21) Appl. No.: 18/971,348

(22) Filed: Dec. 6, 2024

(30) Foreign Application Priority Data
Dec. 18, 2023 (JP) 2023-213127

(51) Int. Cl. H02J 7/35; B60R 16/033; H02J 7/00; H02M 1/00; H02M 3/335

(52) U.S. Cl. CPC H02J 7/35; B60R 16/033; H02J 7/0031; H02J 7/0034; H02M 1/0048; H02M 3/33592; H02J 2207/20

(57) ABSTRACT

A solar charging control device for controlling charging of a first battery using electric power generated by a solar panel, the solar charging control device comprising: a synchronous rectification type DCDC converter provided between the solar panel and the first battery; and a protective circuit inserted between DCDC converter and the first battery to electrically shut off DCDC converter and the first battery when a current flowing backward from the first battery to DCDC converter is detected or when an output voltage of DCDC converter becomes lower than a voltage of the first battery.

### CROSS-REFERENCE TO RELATED APPLICATION

This application claims priority to Japanese Patent Application No. 2023-213127 filed on Dec. 18, 2023, incorporated herein by reference in its entirety.

### BACKGROUND

### 1. Technical Field

The present disclosure relates to a solar charging control device or the like that controls charging of a battery using power generated by a solar panel.

### 2. Description of Related Art

Japanese Unexamined Patent Application Publication No. 2014-003728 (JP 2014-003728 A) discloses a device that can suppress a loss of power caused by a rectifier diode in a step-up direct current-direct current converter. In the device, when a voltage (input voltage) of an anode of the rectifier diode is higher than a voltage (output voltage) of a cathode, a switching element provided in parallel with the rectifier diode is operated to cause a current to flow, and a loss of power of the rectifier diode is suppressed.

### SUMMARY

In order to further reduce a loss of power in the direct current-direct current converter, it is necessary for the rectifier diode to be replaced with a switching element such as a field effect transistor (FET) that can be operated with synchronous rectification.

However, when the synchronous rectification direct current-direct current converter is used for power generation control of a solar panel, in which a panel voltage tends to fluctuate significantly, if the voltage on an output side becomes higher than the voltage on the solar panel side during synchronous rectification, an unintended back-flow of current occurs. There is a fear that such a back-flow of current causes a breakdown of the solar panel or the switching element.

The present disclosure has been made in view of the problem, and an objective of the present disclosure is to provide a solar charging control device or the like that can reduce a loss of power in a direct current-direct current converter while preventing an unintended back-flow of current.

In order to solve the problem, one aspect of the present disclosure technology is a solar charging control device that controls charging of a first battery using power generated by a solar panel, the solar charging control device includes a direct current-direct current converter provided between the solar panel and the first battery, the direct current-direct current converter being a synchronous rectification direct current-direct current converter, and a protective circuit inserted between direct current-direct current converter and the first battery, the protective circuit being configured to electrically disconnect the direct current-direct current converter and the first battery when a current flowing back from the first battery to the direct current-direct current converter is detected or when an output voltage of the direct current-direct current converter becomes lower than a voltage of the first battery.

According to the solar charging control device of the present disclosure, a back-flow of current can be prevented by a protective circuit, and a loss of power in a direct current-direct current converter can be reduced by using a synchronous rectification direct current-direct current converter.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a solar charging control device according to an embodiment of the present disclosure;

FIG. 2A is a specific configuration of the protective circuit shown in FIG. 1;

FIG. 2B is another specific configuration of the protective circuit shown in FIG. 1;

FIG. 3 is an exemplary solar charging control device according to an embodiment of the present disclosure; and

FIG. 4 is another application of a solar charging control device according to an embodiment of the present disclosure.

### DETAILED DESCRIPTION OF EMBODIMENTS

The solar charging control device according to the present disclosure provides a protective circuit that prevents a current flowing back to a direct current-direct current (DCDC) converter, while using a FET in the step-up upper arm element of the step-up and step-down DCDC converter for charging and controlling the generated power of the solar panel. This can reduce a loss of power in DCDC converters.

Hereinafter, an embodiment of the present disclosure will be described in detail with reference to the drawings.

### Embodiment

### Base Configuration

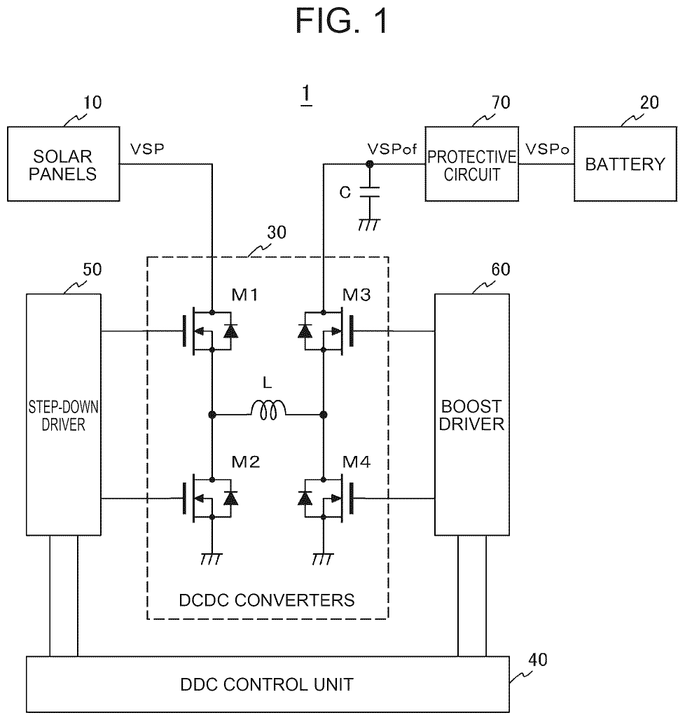

FIG. 1 is a block diagram illustrating a schematic configuration of a solar charging control device 1 according to an embodiment of the present disclosure. The solar charging control device 1 illustrated in FIG. 1 includes a solar panel 10, a battery 20, a DCDC converter 30, a DDC control unit 40, a step-down driver 50, a step-up driver 60, and a protective circuit 70. The solar charging control device 1 can be mounted on a vehicle or the like.

The solar panel 10 is a power generation device that generates electric power by being irradiated with sunlight, and is typically a solar cell module that is an aggregate of solar cells. The solar panel 10 can be installed in, for example, a roof of a vehicle. The solar panel 10 is connected to DCDC converter 30, and electric power generated by the solar panel 10 is outputted to DCDC converter 30.

The battery 20 is a secondary battery configured to be chargeable and dischargeable, such as a lithium-ion battery. The battery 20 is connected to DCDC converter 30 so as to be able to be charged by electric power generated in the solar panel 10.

DCDC converter 30 is a step-up and step-down DCDC converter for supplying electric power generated by the solar panel 10 to the battery 20. When supplying power, DCDC converter 30 can convert (step-up/step-down) the panel voltage VSP, which is the generated voltage of the solar panel 10, which is the input voltage, into a predetermined voltage VSPof and output it to the battery 20 via the protective circuit 70. DCDC converter 30 is of a synchronous rectification type including a switching element M1 which is an upper arm element for step-down, a switching element M2 which is a lower arm element for step-down, a switching element M3 which is a step-up upper arm element, a switching element M4 which is a lower arm element for step-up, and a coil L.

The switching elements M1, M2, M3 and M4 are active elements capable of controlling switching of ON/OFF by the step-down driver 50 and the step-up driver 60 under an instruction from DDC control unit 40, and are transistors, for example. The switching elements M1, M2, M3 and M4 are capable of causing a current to flow when ON control (ON voltage applied to the gate) is performed. For example, Metal Oxide Semiconductor Field Effect Transistor (MOSFET) can be used as the transistor. The coil L is a passive element capable of generating a magnetic field by a flowing current and storing magnetic energy. For the coil L, for example, a choke coil having a constant current characteristic for maintaining a current can be used.

The switching element M1 is connected to the solar panel 10 (positive electrode outputting terminal). The drain of the switching element M1 is connected to the source of the switching element M2. The drain of the switching element M2 is grounded (ground potential). The switching element M3 is connected to the battery 20 via the protective circuit 70. The drain of the switching element M3 is connected to the source of the switching element M4. The drains of the switching elements M4 are grounded. The switching elements M1 and M2 are connected to the step-down driver 50, respectively. The gates of the switching elements M3 and M4 are connected to the step-up driver 60, respectively. The coil L is inserted between a connection point between the drain of the switching element M1 and the source of the switching element M2 and a connection point between the drain of the switching element M3 and the source of the switching element M4.

DCDC converter 30 forms a step-down circuit by the switching element M1, the switching element M2, and the coil L, and can step down the output voltage from the solar panel 10 and output the voltage to the battery 20. In addition, DCDC converter 30 can form a booster circuit by the coil L, the switching element M3, and the switching element M4, boost the output voltage from the solar panel 10, and output the booster circuit to the battery 20.

DDC control unit 40 is configured to control the power exchange between the solar panel 10 and the battery 20 by controlling the operation (step-up/step-down) of DCDC converter 30. DDC control unit 40 instructs the step-down driver 50 and the step-up driver 60 to set the duty ratio (ON ratio of the switching element) of the switching element M1, M2, M3 and the signal applied to the gate of M4 so that the output voltage of DCDC converter 30 becomes a predetermined target voltage. DDC control unit 40 includes, for example, a processor such as a CPU.

The step-down driver 50 and the step-up driver 60 control the gate voltages of the switching elements M1, M2, M3 and M4 in accordance with an instruction from DDC control unit 40 to independently control the on/off operations of the respective switching elements. As a result, the panel voltage VSP of the solar panel 10 is controlled.

The protective circuit 70 is inserted between DCDC converter 30 and the battery 20, and is configured to electrically shut off DCDC converter 30 and the battery 20 when a current flowing backward from the battery 20 to DCDC converter 30 is detected. For example, the following configuration is used for the protective circuit 70.

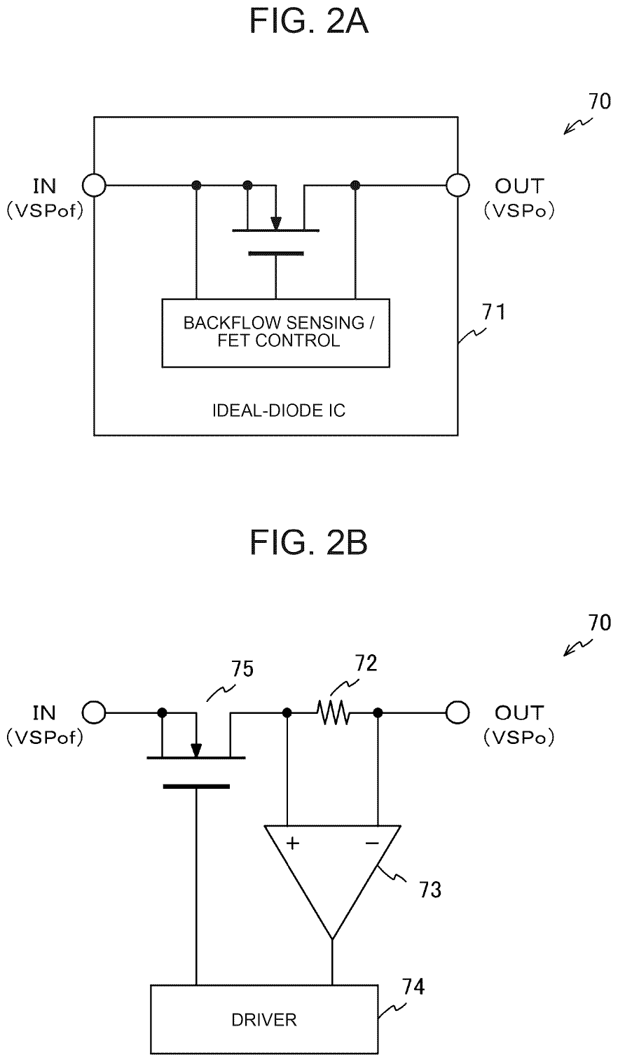

As a specific configuration that can be applied to the protective circuit 70, an ideal diode IC 71 shown in FIG. 2A can be exemplified. The ideal diode IC 71 is an integrated circuit (IC) that realizes an ideal diode property in which the forward voltage is zero and current flows only in one direction. Therefore, the ideal diode IC 71 can significantly reduce a loss of power compared to a discrete rectifier diode. Voltage DCDC converter voltage VSPof is the output voltage of the 30, since the transient variation is suppressed by the capacitor C for smoothing, even when the current flows back to DCDC converter 30 and becomes smaller than the voltage VSPo of the battery 20 ideal diode IC 71 can be controlled to follow.

As another specific configuration applicable to the protective circuit 70, an electric circuit including a resistor 72, an operational amplifier 73, a driver 74, and a switching element (FET) 75 shown in FIG. 2B can be exemplified. In this electric circuit, a current flowing backward through the switching element 75 is detected by the resistor 72 and the operational amplifier 73 (detection unit), and when the backflow is detected, the driving (ON operation) of the switching element 75 by the driver 74 is stopped.

### Applications of Configuration

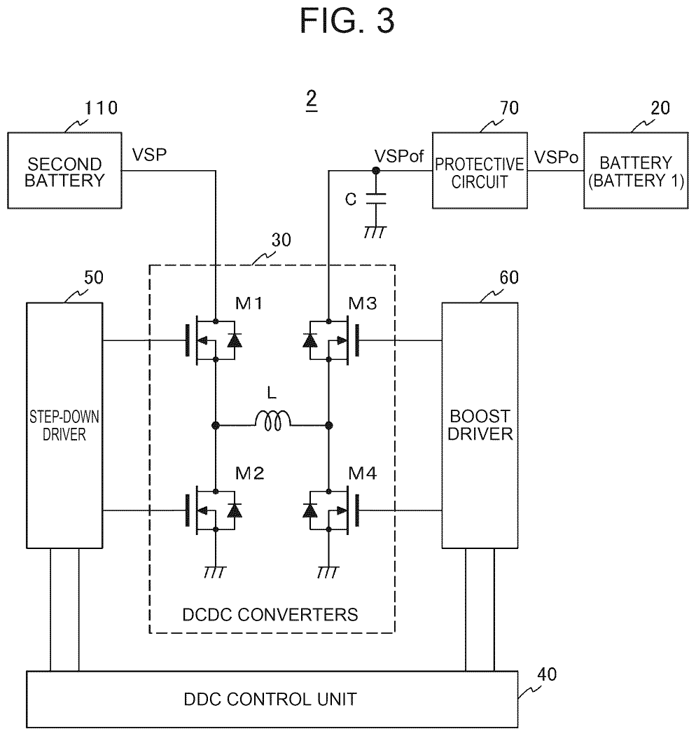

FIG. 3 is a block diagram illustrating a schematic configuration of an application solar charging control device 2 according to an embodiment of the present disclosure. The solar charging control device 2 illustrated in FIG. 3 has a configuration in which the solar panel 10 of the solar charging control device 1 illustrated in FIG. 1 is replaced with a second battery 110.

As shown in FIG. 3, in a system in which the power source for charging the battery (first battery) 20 is not the solar panel 10, but is another battery power source such as the second battery 110, the solar charging control device 2 of the present disclosure is useful when it is desired to prevent a back-flow of current from the battery (first battery) 20 to the second battery 110.

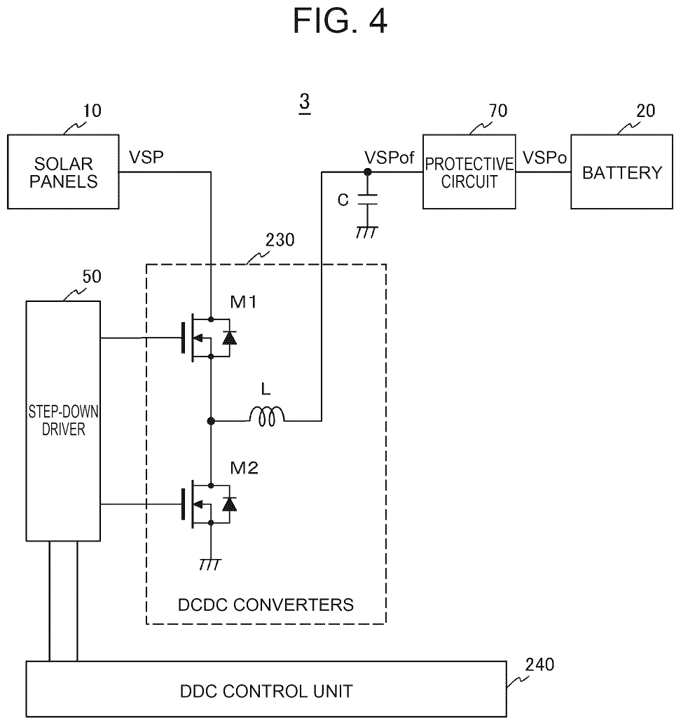

FIG. 4 is a block diagram illustrating a schematic configuration of another applicable solar charging control device 3 according to an embodiment of the present disclosure. The solar charging control device 3 illustrated in FIG. 4 has a configuration in which the step-up and step-down DCDC converter 30 of the solar charging control device 1 illustrated in FIG. 1 is replaced with a step-down DCDC converter 230, and DDC control unit 40 for controlling the step-up/step-down is replaced with DDC control unit 240 for controlling only the step-down.

As shown in FIG. 4, in the configuration of another DCDC converter, such as the configuration using the step-down DCDC converter 230 that operates only when the panel voltage VSP of the solar panel 10 is higher than the voltage VSPo of the battery 20, it is possible to restrain a back-flow of current from the battery 20 to the solar panel 10. Of course, the solar panel 10 of FIG. 4 may be replaced with the second battery 110 of FIG. 3.

### Effects

According to the solar charging control device of the embodiment of the present disclosure described above, in the configuration in which the step-up upper arm element of DCDC converter is a switching element that operates by synchronous rectification, when a current flowing back through DCDC converter is generated due to a variation in the input/output voltage, the path is interrupted by a protective circuit provided at the output of DCDC converter (step-up upper arm element).

With this configuration, it is possible to eliminate the rectifier diode having a large loss of power, and thus it is possible to improve the efficiency of converting DCDC converters. Further, since the reverse current of DCDC converters can be restrained, there is no need to worry about breakage of the panel and the elements in the synchronous rectification system, and the solar charging system using the solar panel as a power source can be applied without fail.

Although an embodiment of the present disclosure has been described above, the present disclosure can be regarded as not only a solar charging control device but also a method performed by the solar charging control device, a program of the method, a computer-readable non-transitory storage medium storing the program, a vehicle including the solar charging control device, and the like.

The solar charging control device of the present disclosure can be used in a solar charging system or the like that charges a battery with generated electric power of a solar panel.

What is claimed is:

1. A solar charging control device that controls charging of a first battery using power generated by a solar panel, the solar charging control device comprising:
a direct current-direct current converter provided between the solar panel and the first battery, the direct current-direct current converter being a synchronous rectification direct current-direct current converter; and
a protective circuit inserted between the direct current-direct current converter and the first battery, the protective circuit being configured to electrically disconnect the direct current-direct current converter and the first battery when a current flowing back from the first battery to the direct current-direct current converter is detected or when an output voltage of the direct current-direct current converter becomes lower than a voltage of the first battery.

2. A solar charging control device that controls charging of a first battery using power of a second battery, the solar charging control device comprising:
a direct current-direct current converter provided between the first battery and the second battery, the direct current-direct current converter being a synchronous rectification direct current-direct current converter; and
a protective circuit inserted between the direct current-direct current converter and the first battery, the protective circuit being configured to electrically disconnect the direct current-direct current converter and the first battery when a current flowing back from the first battery to the direct current-direct current converter is detected or when an output voltage of the direct current-direct current converter becomes lower than a voltage of the first battery.

3. The solar charging control device according to claim 1, wherein:
the direct current-direct current converter is a step-up and step-down direct current-direct current converter; and
the protective circuit is connected to an output of a step-up upper arm element.

4. The solar charging control device according to claim 2, wherein:
the direct current-direct current converter is a step-up and step-down direct current-direct current converter; and
the protective circuit is connected to an output of a step-up upper arm element.

5. The solar charging control device according to claim 1, wherein:
the direct current-direct current converter is a step-down direct current-direct current converter; and
the protective circuit is connected to an output of a coil.

6. The solar charging control device according to claim 2, wherein:
the direct current-direct current converter is a step-down direct current-direct current converter; and
the protective circuit is connected to an output of a coil.

7. The solar charging control device according to claim 1, wherein the protective circuit is an ideal diode integrated circuit.

8. The solar charging control device according to claim 2, wherein the protective circuit is an ideal diode integrated circuit.

9. The solar charging control device according to claim 1, wherein the protective circuit includes
a switching element that switches a state of conduction and disconnection between the direct current-direct current converter and the first battery,
a detection unit that detects the current flowing back, and
a control unit that stops driving of the switching element when the current flowing back is detected by the detection unit.

10. The solar charging control device according to claim 2, wherein the protective circuit includes
a switching element that switches a state of conduction and disconnection between the direct current-direct current converter and the first battery,
a detection unit that detects the current flowing back, and
a control unit that stops driving of the switching element when the current flowing back is detected by the detection unit.

11. A vehicle mounted with the solar charging control device according to claim 1.

12. A vehicle mounted with the solar charging control device according to claim 2.
